(19) United States
(12) Patent Application Publication
(10) Pub. No.: US 2016/0154543 A1
(43) Pub. Date: Jun. 2, 2016

(54) Generating a List of Content Items

(71) Applicant: Facebook, Inc., Menlo Park, CA (US)

(72) Inventor: Omer Strulovich, New York, NY (US)

(21) Appl. No.: 14/558,315

(22) Filed: Dec. 2, 2014

(51) Int. Cl. G06F 3/0482; G06F 3/0484; H04L 29/08

(52) U.S. Cl. CPC G06F 3/0482; H04L 67/02; G06F 3/04842

(57) ABSTRACT

In one embodiment, a method includes receiving a request to display a first portion of a list comprising content items and for each section of each content item in the first portion, identifying binder objects corresponding to the section, binding data or content to display objects that correspond to the section, and displaying the display objects corresponding to the sections of the content items in the first portion.

### TECHNICAL FIELD

This disclosure generally relates to an improved method of displaying an object-based representation of a graphical user interface (“GUI”).

### BACKGROUND

A mobile computing device—such as a smartphone, tablet computer, or laptop computer—may include functionality for determining its location, direction, or orientation, such as a GPS receiver, compass, gyroscope, or accelerometer. Such a device may also include functionality for wireless communication, such as BLUETOOTH communication, near-field communication (NFC), or infrared (IR) communication or communication with wireless local area networks (WLANs) or cellular-telephone network. Such a device may also include one or more cameras, scanners, touchscreens, microphones, or speakers. Mobile computing devices may also execute software applications, such as games, web browsers, or social-networking applications. With social-networking applications, users may connect, communicate, and share information with other users in their social networks.

Creating display objects and filling them with data or content may constitute a significant cause of latency for complex and content-intensive applications, such as, by way of example and not limitation, those that need to display long lists of content that a user may scroll through. Computing devices may need to render a graphical user interface (GUI) for display comprised of a list of displayable objects. Latency may be detected when responding to GUI-related input (e.g., user interacting with the GUI to request a new display) and may increase as the GUI becomes larger and more complex.

### SUMMARY OF PARTICULAR EMBODIMENTS

In particular embodiments, an object-based representation of a graphical user interface (“GUI”) may be organized so as to provide objects to independently handle execution of application logic; each such object (referred to as a Binder object within the scope of this disclosure) may retrieve, process, and update data or content that is subsequently bound to a display object (e.g., ANDROID's View object) corresponding to a section of a content item.

Upon receiving a request for a list of content items to be displayed (e.g., NewsFeedList object comprising a number of NewsFeedItem objects), the application may generate a set of adapter objects (e.g., AdaptersList object) comprising a content item adapter object (e.g., FeedUnitAdapter object) for each content item in the list. When each adapter object is generated, the adapter object may be initialized with an index of content sections for the content item, after which the adapter object may generate Binder objects each corresponding to a section in the content item. After the Binder objects have been generated, the Binder objects may then prepare the content for their sections by executing application logic to retrieve any necessary content and/or data.

Once the content item is requested for display in the displayable region (e.g., when a list of content items is first requested, or when user input scrolling the list is received), the Binder objects for the content sections of the content item may then bind their prepared data or content to a display object for each content section in the requested content item. Once the content item leaves the visible area (e.g., when user input scrolling the list is received, or when the application is closed or sent to the background), the Binder objects may unbind the prepared data or content from the display objects for the content sections.

In particular embodiments, Binder objects may listen for events that may affect or update their respective content section. After a Binder object has been generated for a content section in the content item, the Binder object may subscribe to listen for particular events or actions that apply to its corresponding content section (and subsequently update its prepared data, unbind its data, bind additional data, or take any other necessary action).

The embodiments disclosed above are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1A illustrates a detailed example of a displayed newsfeed on a device.

FIG. 1B illustrates example content items (e.g., newsfeed stories) in a list of content items (e.g., a newsfeed).

FIG. 2A illustrates an example of the overall object architecture with line representation corresponding to the newsfeed.

FIG. 2B illustrate an example initializing each of the adapters with an index of parts.

FIG. 2C illustrates an example the FeedUnitPart object may implement for creating Binders.

FIG. 3A illustrates an example method for generating a list of content items using Binder objects.

FIG. 3B illustrates an example method for displaying a list of content items.

FIG. 3C illustrates an example method for scrolling through a list of content items.

FIG. 3D illustrates an example method for listening and handling specific events.

FIG. 4 illustrates an example network environment associated with a social-networking system.

FIG. 5 illustrates an example social graph.

FIG. 6 illustrates an example computer system.

### DESCRIPTION OF EXAMPLE EMBODIMENTS

In particular embodiments, an object-based representation of a graphical user interface (“GUI”) may be organized so as to provide objects to independently handle execution of application logic; each such object (referred to as a Binder object within the scope of this disclosure) may retrieve, process, and update data or content that is subsequently bound to a display object (e.g., ANDROID's View object) corresponding to a section of a content item.

Upon receiving a request for a list of content items to be displayed (e.g., NewsFeedList object comprising a number of NewsFeedItem objects), the application may generate a set of adapter objects (e.g., AdaptersList object) comprising a content item adapter object (e.g., FeedUnitAdapter object) for each content item in the list. When each adapter object is generated, the adapter object may be initialized with an index of content sections for the content item, after which the adapter object may generate Binder objects each corresponding to a section in the content item. After the Binder objects have been generated, the Binder objects may then prepare the content for their sections by executing application logic to retrieve any necessary content and/or data.

Once the content item is requested for display in the displayable region (e.g., when a list of content items is first requested, or when user input scrolling the list is received), the Binder objects for the content sections of the content item may then bind their prepared content to a display object for each content section in the requested content item. Once the content item leaves the visible area (e.g., when user input scrolling the list is received, or when the application is closed or sent to the background), the Binder objects may unbind the prepared content from the display objects for the content sections.

In particular embodiments, Binder objects may listen for events that may affect or update their respective content section. After a Binder object has been generated for a content section in the content item, the Binder object may subscribe to listen for particular events or actions that apply to its corresponding content section (and subsequently update its prepared data, unbind its data, bind additional data, or take any other necessary action).

For purposes of illustration and not by way of limitation the example shown herein relates to generating and displaying a newsfeed on a social networking system, the newsfeed being comprised of newsfeed stories. The scope of this disclosure is not limited to the example embodiments described herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend.

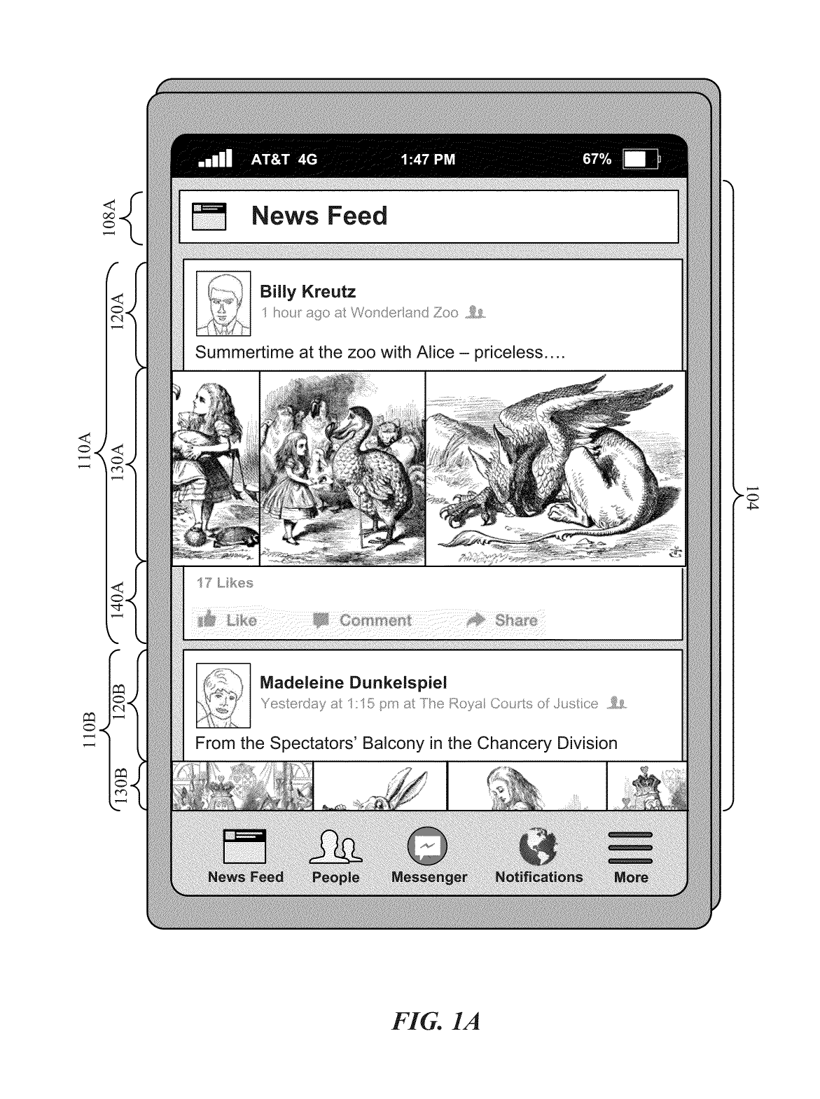

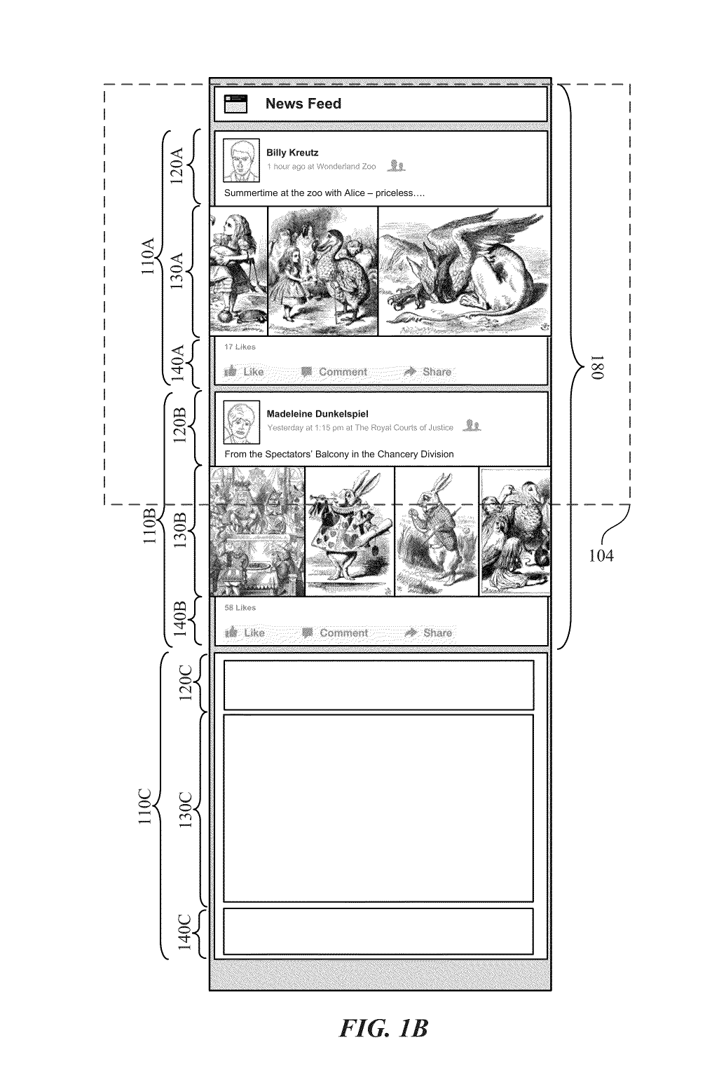

FIG. 1A illustrates a detailed example of a newsfeed displayed on a device. The displayable region 104 contains the content or data that a user of the device is able to view. Displayable region 104 may include the entire screen of the device or a subregion (e.g., a particular window or frame of a GUI presented on the screen of the device). As illustrated in FIG. 1A, the displayable region 104 includes three components: a content list header 108A, a content item 110A, and a partially displayed content item 110B. Content items 110 each contain a number of content sections: a header section 120A, a body section 130A, and a feedback section 140A. Header section 120A may include the personal information associated with the poster of content item 110A or information describing the content or data posted to the content-body section 130A. The body section 130A may include content or data the user has posted for content item 110A, such as a photo, video, web address, simple text, or any other sort of content. The feedback section 140A may display the number of “Likes” a specific content item 110A has received and the number of comments associated with the content item 110A. Content item 110A illustrates an example of a content item that fits entirely within the displayable region 104. On the other hand, content item 110B is only partially positioned within the displayable region 104. As shown in FIG. 1A, certain content sections of partially displayed content item 110B are hidden (e.g., not within the displayable region). For example, content-body section 130B is only partially positioned within the displayable region 104 and the feedback section 140B is completely outside of the displayable region 104.

In the example embodiment illustrated in FIG. 1A, the overall newsfeed list may be represented in a display object hierarchy by a NewsFeedListView object comprising a number of StoryView objects (each corresponding to one of the content items 110). Each StoryView object may include a number of other objects (each corresponding to a content section), such as HeaderView (for header section 120), ContentTextView (for body section 130), and FeedbackView (for feedback section 140), each of which may themselves include child View objects (e.g., the ContentTextView object may include one or more of an ImageView object, a VideoView object, a TextView object, or a MapView object).

FIG. 1B illustrates example content items (e.g., newsfeed stories) in a list of content items (e.g., a newsfeed). As illustrated in FIG. 1B, first portion 180 may include the content items for which data or content has already been bound to the display object for at least one section of the content item. For example, as explained with respect to FIG. 1A, content item 110A illustrates an example of a content item that fits entirely within the displayable region 104. Whereas content item 110B is only partially positioned within the displayable region 104. However, both content item 110A and content item 110B are within first portion 180 because content item 110A is fully visible (i.e., fully positioned within displayable region 104) and content item 110B is partially visible (i.e., partially positioned within the displayable region 104). In contrast to content items positioned (i.e., fully or partially) within displayable region 104, content item 110C is neither fully visible nor partially visible. Content item 110C is positioned entirely outside displayable region 104 and therefore is not within first portion 180.

Once content sections (e.g., header section 120, body section 130, and feedback section 140) in content item 110A and content item 110B are requested for display in displayable region 104, Binder objects corresponding to sections may then bind their prepared data or content to the display object for each content section in the requested content item. First portion 180 may be comprised of all of content items 110 that are fully positioned within the displayable region 104 and content items 110 that are only partially positioned within the displayable region 104. In some embodiments, data or content may only be bound for those particular sections appearing in displayable region 104 (e.g., data or content for feedback section 140B, which is not positioned within displayable region 104 may not have yet been bound to a display object corresponding to feedback section 140B, although data or content for other sections of the same content item—body section 130B and 120B—have been bound to display objects corresponding to those content sections).

In particular embodiments, data or content may only be bound to display objects for content items (or for only those content sections) at least partially within first portion 180, while content items (or content sections) beyond first portion 180 may remain unbound until user input positioning such content items or content sections within displayable region 104 is received. In contrast, as illustrated in FIG. 1B, none of the content sections in content item 110C have display objects to which data or content has been bound because content item 110C is not within first portion 180.

In some embodiments, once every content section of a given content item 110 has left displayable region 104, Binder objects may unbind the content or data from the display objects for the content sections of that content item 110. In other embodiments, as each content section of a given content item 110 leaves displayable region 104, the Binder object corresponding to the now-hidden content section may unbind the content or data from the display object for that content section.

In some embodiments, the application may render and cache additional displayable objects in addition to the currently displayed content items. That is, first portion 180 may include additional content items 110 positioned entirely outside displayable region 104. For example, first portion 180 may include content item 110C. As a result, the Binder objects for the content sections of content item 110C would have already bound their prepared content or data to the display objects for content item 110C even though content item 110C is positioned entirely outside displayable region 104. This allows content item's 110C displayable objects to be rendered and cached before entering displayable region 104.

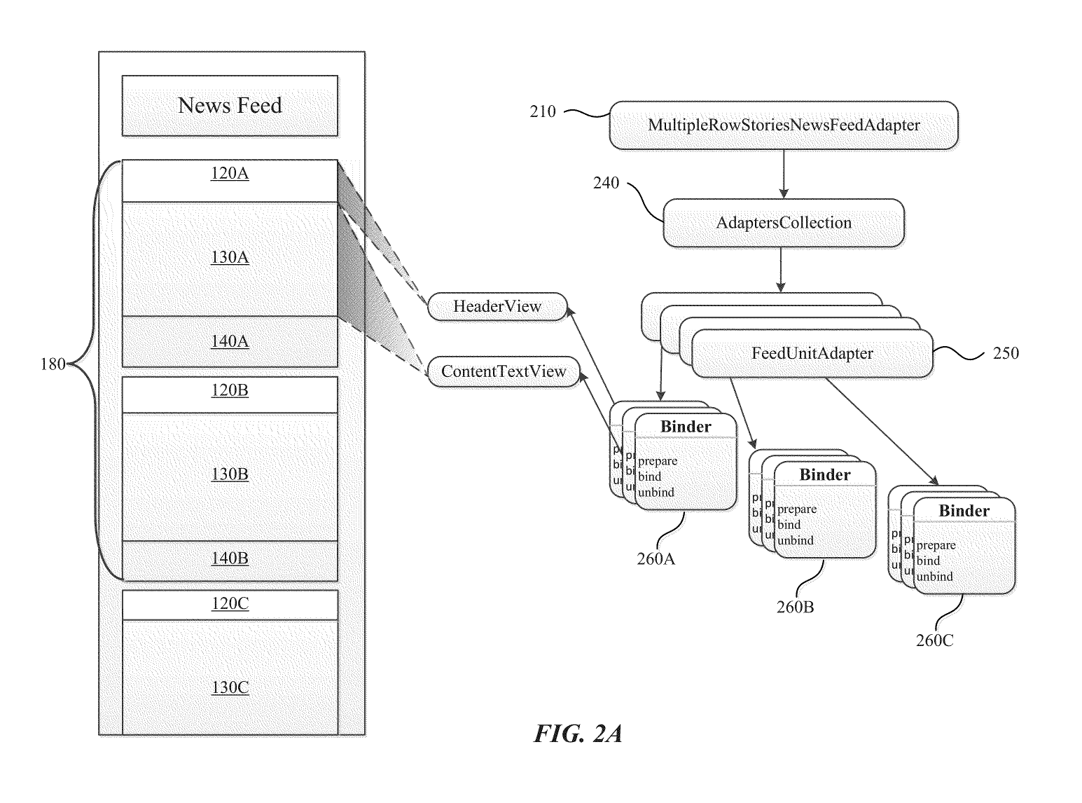

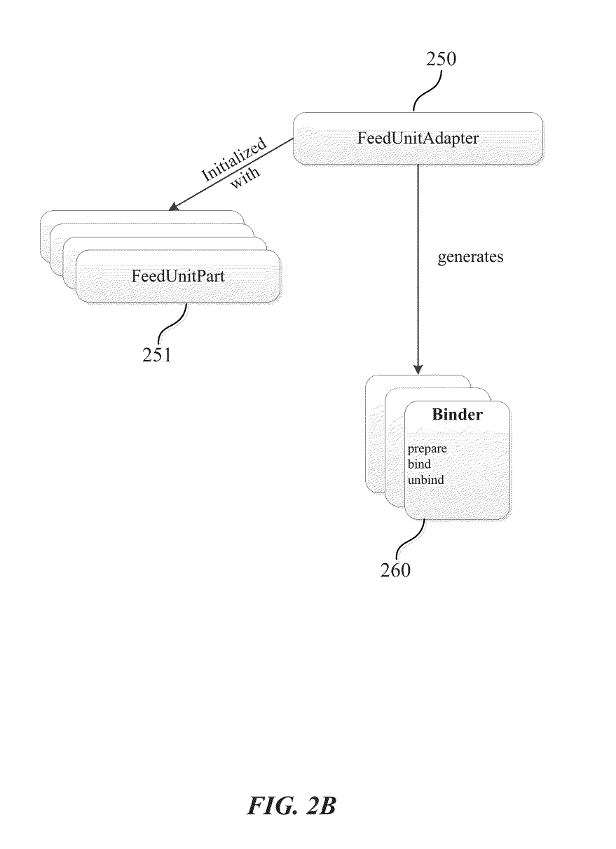

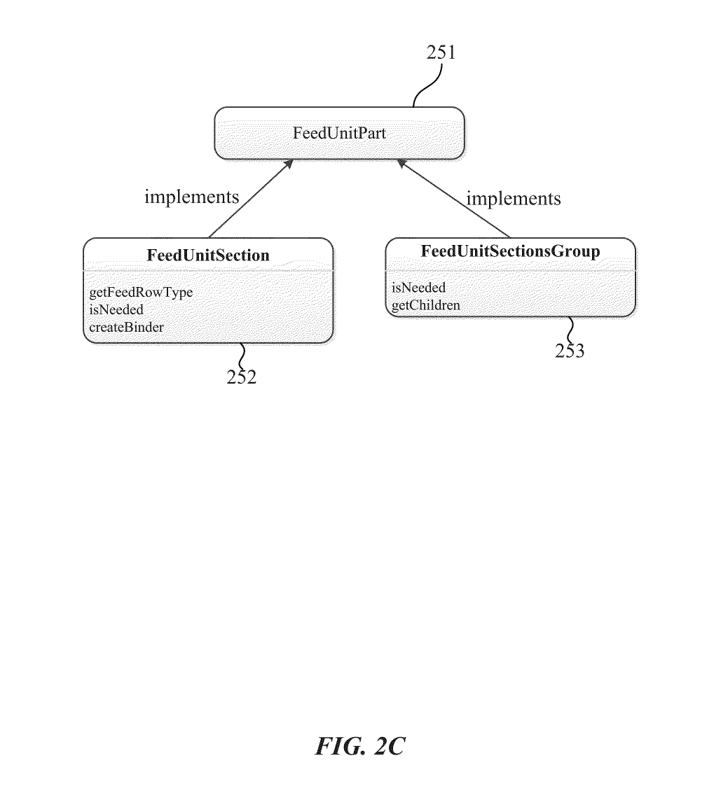

FIGS. 2A-2C illustrate an example object architecture for generating the example newsfeed illustrated in FIGS. 1A and 1B. As shown in FIG. 2A, the adapter object for the NewsFeedListView display object—MultipleRowStoriesNewsFeedAdapter 210—accesses an object (AdaptersCollection 240) that generates a number of adapter objects (FeedUnitAdapters 250) corresponding to all of the content items (in order) required to generate a particular newsfeed for a user. As further illustrated in FIG. 2B, each FeedUnitAdapter 250 may be initialized with an index of FeedUnitPart 251 objects (e.g., a FeedUnitPart interface may be implemented by a FeedUnitSection 252 object or a FeedUnitSectionsGroup 253, as shown in FIG. 2C). Each FeedUnitPart 251 may correspond to one of the content sections in the content item 110 corresponding to a particular FeedUnitAdapter 250. The FeedUnitAdapter 250 then generates a Binder 260 object for each FeedUnitPart 251.

In particular embodiments, Binder 260 may perform three different functions: prepare, bind, and unbind. When Binder 260 is generated, it may first prepare the data or content for its corresponding content section before binding the prepared data or content to a display object. For example, Binder 260 may be assigned to feedback section 140, and when its prepare function is called, Binder 260 may gather all of the relevant data or content contained in feedback section 140 for display. After Binder 260 has prepared all the data or content needed for a display object corresponding to the appropriate content section, its bind function may be called in order to bind the prepared data or content to the display object to set the appropriate view for the user. Once the content section (or its content item) is no longer positioned in displayable region 104, Binder 260's unbind function may be called to unbind the data or content from the display object after leaving displayable area 104.

In some embodiments, when rendering a content layout for a particular display screen where one or two of the content items extend beyond displayable region 104, Binders 260 for such partially displayed content items 110 may bind the prepared data or content to display objects for all sections of such content items 110; in other embodiments, Binders 260 for such partially displayed content items 110 may bind the prepared data to only those sections that are at least partially displayed as they appear in the displayable region. In particular embodiments, after Binder 260 unbinds the prepared data from their corresponding display objects, the display objects may be recycled.

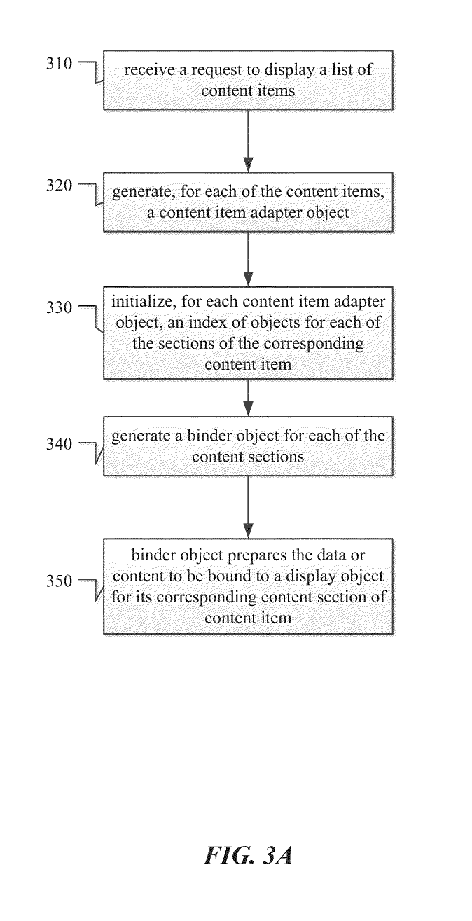

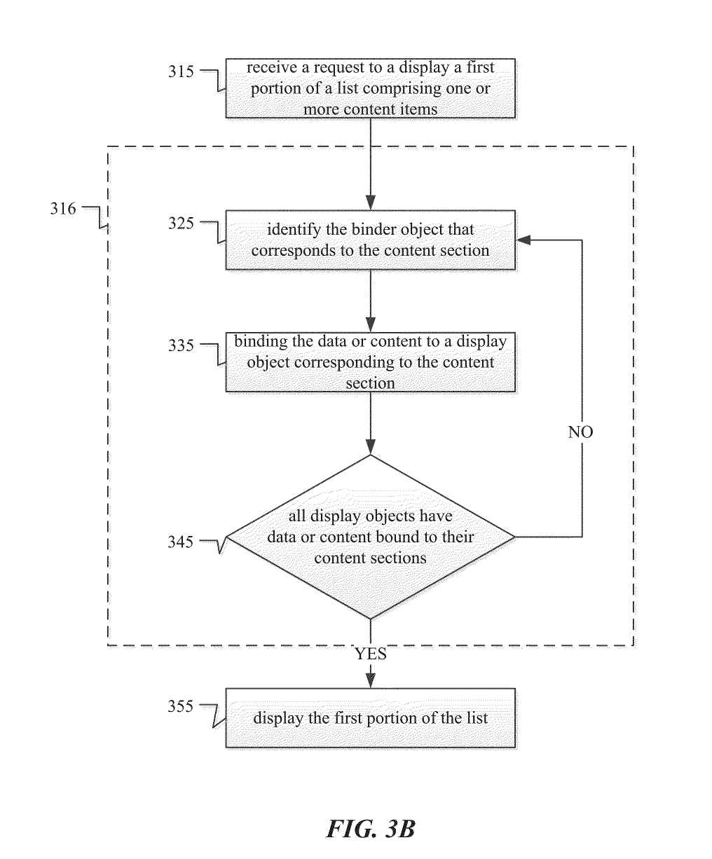

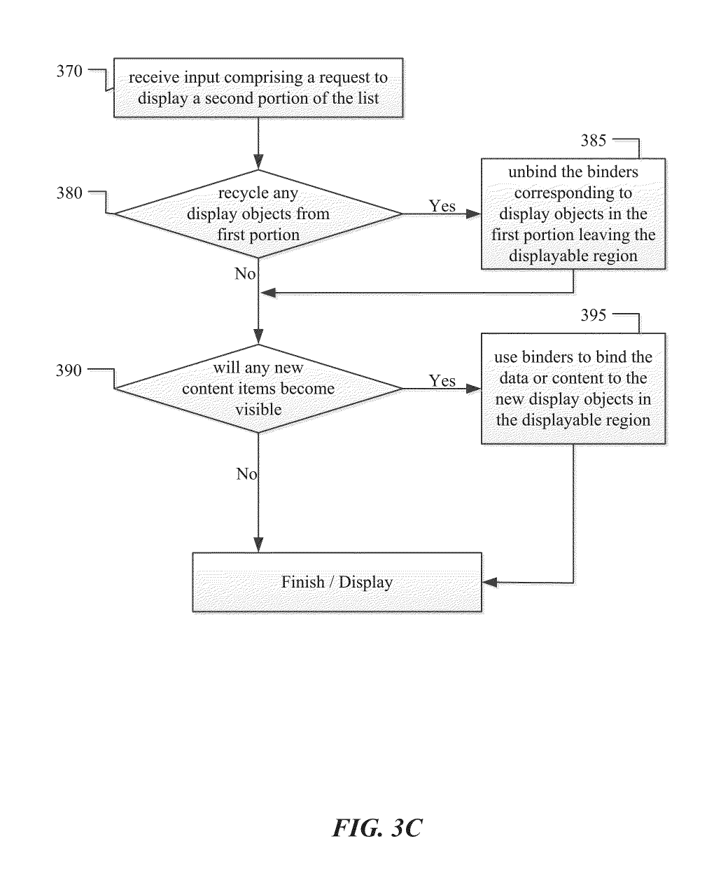

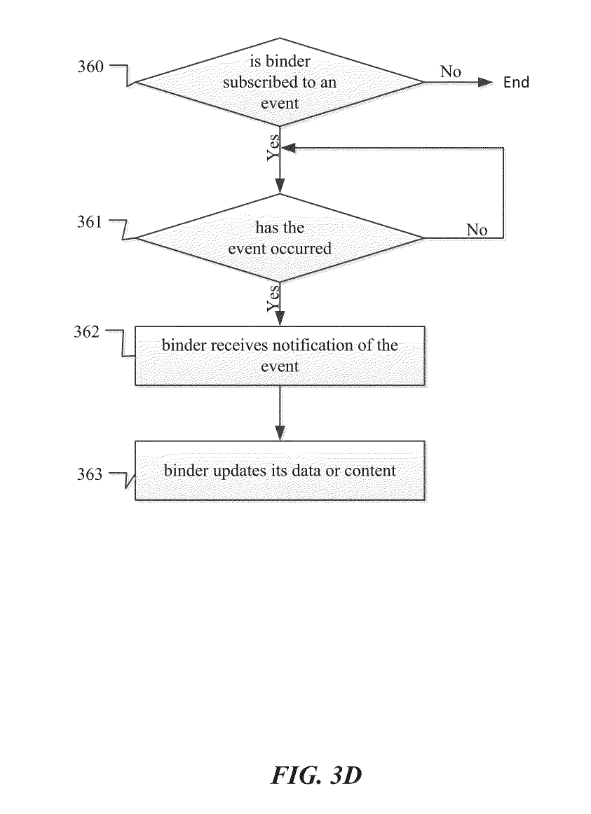

FIG. 3A illustrates an example method for generating a list of content items (e.g., a newsfeed comprising newsfeed stories) using Binder 260. The method may begin at step 310, where the application receives a request to display a list of content items (e.g., upon receiving a request for a list of content items to be displayed, such as, by way of example and not limitation, upon receiving an initial request to display the list of content items, upon receiving instructions to refresh the list, or upon receiving instructions to re-order content items in the list).

At step 320, for each of the content items, the application may generate a content item adapter object for each of the content items (e.g., newsfeed stories) required to generate a particular newsfeed for a user.

At step 330, each content item adapter object may be initialized with an index of objects for each of the sections of the corresponding content item. In particular embodiments, for each content section in content item 110 there may be a corresponding FeedUnitPart 251.

In the newsfeed example illustrated in FIGS. 2A-2C, each FeedUnitAdapter 250 may be initialized with an index of FeedUnitPart 251 objects, e.g., FeedUnitSections 252 that implement a FeedUnitPart interface. In one example, a particular FeedUnitSection 252 may be associated with a particular type of content section (e.g., header section 120, content section 130, feedback section 140) that incorporates particular types of content or data, that has a particular layout with respect to the GUI, or that must provide particular types of interactivity or functionality. In particular embodiments, FeedUnitSection 252 may include an indication as to whether the particular content section is needed (e.g., if a particular content item only displays a feedback section when the user has configured their permissions to allow people to comment on their posts, FeedUnitSection 252 may include an indication as to whether the permissions have been configured to allow feedback, therefore requiring display of the feedback section). FeedUnitSection 252 may also create a corresponding Binder 260 to prepare its content or data and bind/unbind the content or data to a display object as needed. In some embodiments, a FeedUnitSectionsGroup 253 may also implement the FeedUnitPart interface. FeedUnitSectionsGroup 253 may create new children (e.g., creating new sub-sections within content sections, such as a listing of comments responding to a particular newsfeed story), which may be instantiated as FeedUnitSections 252.

At step 340, Binder 260 is generated for each content section. In particular embodiments, each FeedUnitSection 252 may generate a Binder 260 for its content section once the application has received a request to display the newsfeed comprised of newsfeed stories. In further embodiments, each FeedUnitSection 252 may generate a Binder 260 on an as-needed basis. For example, for a very long content list including 500 content items, FeedUnitAdapter 250 may only choose to generate Binders 260 for the first 50 content items (and then generate Binders 260 for additional content items as the user scrolls down the list).

At step 350, Binder 260 prepares the data or content to be bound to a display object for its corresponding content section of content item 110. For example, as shown in FIG. 2A, Binder 260 may prepare the data or content contained in Feedback section 140B for content item 110B.

In particular embodiments, Binder 260 may handle execution of application logic to retrieve the data or content appearing in its corresponding content section of a content item. For example, after Binder 260 has been generated, Binder 260 may perform the required operations to retrieve, process, or format data before content items 110 are positioned within displayable region 104.

In particular embodiments the application may receive new content item 110 (e.g., a newsfeed story) from the social networking system that need to be added to the already existing list of content items 110 in AdaptersCollection 240. Upon receiving new content item 110 the application may generate a new FeedUnitAdapter 250 corresponding to new content item 110. FeedUnitAdapter 250 may then be initialized with an index of FeedUnitPart 251 objects (e.g., FeedUnitSection 252 or FeedUnitSectionsGroup 253) for each new content item 110. FeedUnitAdapter 250 then generates a Binder 260 object for each FeedUnitPart 251 (content section). After Binder 260 has been generated, Binder 260 may then prepare content or data for its corresponding content section of new content item 110 by executing application logic to retrieve any necessary content and/or data.

FIG. 3B illustrates an example method for displaying a list of content items (e.g., a newsfeed comprising newsfeed stories) using Binder objects. At step 315, a request is received to display first portion 180 of a list of content items 110. In particular embodiments each content item 110 may contain a plurality of content sections.

At step 316, indicated by the dashed line, after the request has been received, the application may perform the following steps for each content section of each content item 110 positioned within first portion 180.

At step 325, the application identifies the Binder 260 that corresponds to the content section to be displayed. In particular embodiments, Binder 260 may have already prepared the data or content to be bound to a display object corresponding to its respective content section in content item 110. In some embodiments, Binder 260 may not prepare the data or content to be bound to a display object displayed in the content section until the application identifies Binder 260.

At step 335, Binder 260 binds its prepared data or content to a display object corresponding to the content section in content item 110.

At step 345, the application confirms that the data or content for all of the content sections of first portion 180 have been bound to a display object, and at step 355 first portion 180 of the list (e.g., the set of display objects to which data or content has been bound) may be displayed.

FIG. 3C illustrates an example method for scrolling or otherwise navigating through the newsfeed list. At step 370 the application may receive a request to display a second portion of the list. For example, a user may wish to reveal content items 110 that are currently not in displayable region 104 by scrolling through the newsfeed to display second portion of the list.

At step 380, the application may determine whether any content items from the first portion 180 of the list are no longer positioned within displayable region 104. For any such content item, at step 385, the Binders 260 corresponding to the content sections of the content item may unbind the prepared data or content from the display objects for those content sections no longer positioned within displayable region 104. After the display object is no longer bound to any data or content, the application may allow the display object to be recycled (e.g., returned to a pool of display objects).

At step 390, the application then determines whether any new content items 110 may become positioned within displayable region 104. If new content item 110 will become partially or entirely positioned within displayable region 104, at step 395, Binders 260 for content sections of the new content item 110 may bind their data or content to display objects. However, if no new content items 110 will become positioned within display region 104, no Binders 260 may need to bind any data or content to any of the display objects.

In particular embodiments the application may receive a request to hide or minimize the list of newsfeed items, or to send the application to the background or otherwise suspend the application. In response to receiving the input by a user to move the newsfeed item from display on a user's device, the application may, for each content item 110 in first portion 180, unbind the retrieved data or content from the display object corresponding to the appropriate content section.

FIG. 3D illustrates an example method for listening and handling specific events. At step 360 the application may identify which Binders 260 are listening for the occurrence of a particular type of event (e.g., those Binders 260 that have subscribed to listen for particular types of events). Next, at step 361, as the Binders 260 listen for a particular event to occur, the application may notify (step 362) those Binders 260 listening for the particular type of event about the occurrence of the event. Upon receiving such a notification, the Binders 260 may update the data or content corresponding to its respective content section at step 363.

In particular embodiments, events (e.g., feedback section 140 receiving a “Like”) may be assigned a unique key that allows Binders 260 to subscribe to only that specific type of event. For example, in particular embodiments, an EventsStream object may permit a subscriber (e.g., Binder 260) or a global event handler to listen for specific events affecting the data or content within a particular content section assigning unique keys to different types of events. In particular embodiments, Binder 260 may only subscribe to events affecting or updating Binder's 260 content section.

In particular embodiments, Binder 260 may subscribe to particular events or occurrences while executing its prepare function. For example, if content item 110 (e.g., a newsfeed story) is only partially within displayable region 104 (e.g., only header section 120 and content section 130 are visible, but feedback section 140 is not positioned within displayable region 104), when a click on feedback section 140 occurs (e.g., a click on the “Like” button has occurred), Binder 260 may receive a notification of the event and update its data or content, so that the area which may display the total number of “Likes” may be updated by Binder 260 before Binder 260 binds to the display object. In particular embodiments, Binder 260 may subscribe to multiple events that may affect or update the respective content section for that Binder 260.

In particular embodiments, Binder 260 may continue to listen for events or actions that may affect Binder 260 even though Binder's 260 content section is located within displayable region 104. For example, Binder's 260 content section may be within displayable region 104 when a click on the “Like” button has occurred. Binder 260 may update the content section displaying the appropriate number of “Likes.” In particular embodiments, Binder 260 may unbind while within displayable region 104, update the data or content upon the occurrence of the event affecting the content section, and then re-bind the updated data or content to the display object corresponding to the content section.

In further embodiments, Binder 260 may not be listening for the occurrence of specific events, but prior to entering displayable region 104 Binder 260 may update the data or content contained within Binder's 260 respective content section.

In further embodiments, if first portion 180 has remained within displayable region 104 for more than a predetermined set of time (e.g., 30, 60, 90 . . . 180 seconds) Binder 260 may unbind from the display object, update its data or content, and the re-bind to the display object's respective content section to ensure content items 110 contain the most up-to-date information.

In some embodiments, when Binder 260 is destroyed, Binder 260 may be automatically unsubscribed from any events.

In further embodiments, global event handlers may also subscribe to listen for particular events or occurrences. In particular embodiments a global event handler may subscribe to events that may affect any section or content item 110 located within the newsfeed list. In particular embodiments, the global event handler may subscribe to any event or occurrence that may occur within the entire newsfeed list (e.g., updates to data or content occurring outside of content sections and content items 110).

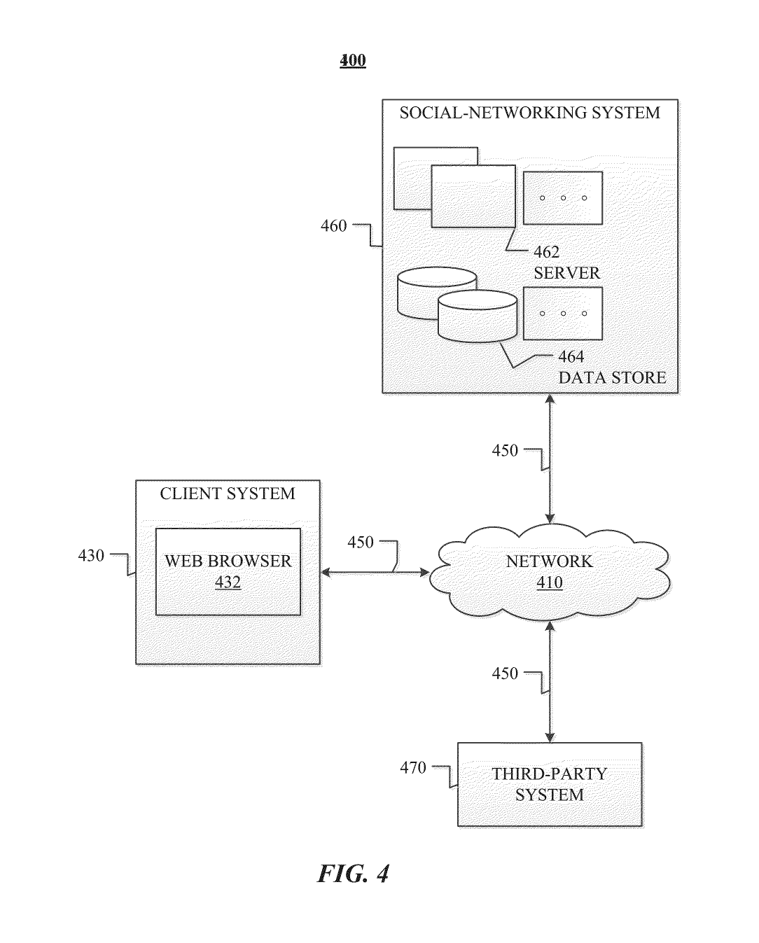

FIG. 4 illustrates an example network environment 400 associated with a social-networking system. Network environment 400 includes a client system 430, a social-networking system 460, and a third-party system 470 connected to each other by a network 410. Although FIG. 4 illustrates a particular arrangement of client system 430, social-networking system 460, third-party system 470, and network 410, this disclosure contemplates any suitable arrangement of client system 430, social-networking system 460, third-party system 470, and network 410. As an example and not by way of limitation, two or more of client system 430, social-networking system 460, and third-party system 470 may be connected to each other directly, bypassing network 410. As another example, two or more of client system 430, social-networking system 460, and third-party system 470 may be physically or logically co-located with each other in whole or in part. Moreover, although FIG. 4 illustrates a particular number of client systems 430, social-networking systems 460, third-party systems 470, and networks 410, this disclosure contemplates any suitable number of client systems 430, social-networking systems 460, third-party systems 470, and networks 410. As an example and not by way of limitation, network environment 400 may include multiple client system 430, social-networking systems 460, third-party systems 470, and networks 410.

This disclosure contemplates any suitable network 410. As an example and not by way of limitation, one or more portions of network 410 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 410 may include one or more networks 410.

Links 450 may connect client system 430, social-networking system 460, and third-party system 470 to communication network 410 or to each other. This disclosure contemplates any suitable links 450. In particular embodiments, one or more links 450 include one or more wireline (such as for example Digital Subscriber Line (DSL) or Data over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 450 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 450, or a combination of two or more such links 450. Links 450 need not necessarily be the same throughout network environment 400. One or more first links 450 may differ in one or more respects from one or more second links 450.

In particular embodiments, client system 430 may be an electronic device including hardware, software, or embedded logic components or a combination of two or more such components and capable of carrying out the appropriate functionalities implemented or supported by client system 430. As an example and not by way of limitation, a client system 430 may include a computer system such as a desktop computer, notebook or laptop computer, netbook, a tablet computer, e-book reader, GPS device, camera, personal digital assistant (PDA), handheld electronic device, cellular telephone, smartphone, other suitable electronic device, or any suitable combination thereof. This disclosure contemplates any suitable client systems 430. A client system 430 may enable a network user at client system 430 to access network 410. A client system 430 may enable its user to communicate with other users at other client systems 430.

In particular embodiments, client system 430 may include a web browser 432, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 430 may enter a Uniform Resource Locator (URL) or other address directing the web browser 432 to a particular server (such as server 462, or a server associated with a third-party system 470), and the web browser 432 may generate a Hyper Text Transfer Protocol (HTTP) request and communicate the HTTP request to server. The server may accept the HTTP request and communicate to client system 430 one or more Hyper Text Markup Language (HTML) files responsive to the HTTP request. Client system 430 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, social-networking system 460 may be a network-addressable computing system that can host an online social network. Social-networking system 460 may generate, store, receive, and send social-networking data, such as, for example, user-profile data, concept-profile data, social-graph information, or other suitable data related to the online social network. Social-networking system 460 may be accessed by the other components of network environment 400 either directly or via network 410. As an example and not by way of limitation, client system 430 may access social-networking system 460 using a web browser 432, or a native application associated with social-networking system 460 (e.g., a mobile social-networking application, a messaging application, another suitable application, or any combination thereof) either directly or via network 410. In particular embodiments, social-networking system 460 may include one or more servers 462. Each server 462 may be a unitary server or a distributed server spanning multiple computers or multiple datacenters. Servers 462 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 462 may include hardware, software, or embedded logic components or a combination of two or more such components for carrying out the appropriate functionalities implemented or supported by server 462. In particular embodiments, social-networking system 460 may include one or more data stores 464. Data stores 464 may be used to store various types of information. In particular embodiments, the information stored in data stores 464 may be organized according to specific data structures. In particular embodiments, each data store 464 may be a relational, columnar, correlation, or other suitable database. Although this disclosure describes or illustrates particular types of databases, this disclosure contemplates any suitable types of databases. Particular embodiments may provide interfaces that enable a client system 430, a social-networking system 460, or a third-party system 470 to manage, retrieve, modify, add, or delete, the information stored in data store 464.

In particular embodiments, social-networking system 460 may store one or more social graphs in one or more data stores 464. In particular embodiments, a social graph may include multiple nodes—which may include multiple user nodes (each corresponding to a particular user) or multiple concept nodes (each corresponding to a particular concept)—and multiple edges connecting the nodes. Social-networking system 460 may provide users of the online social network the ability to communicate and interact with other users. In particular embodiments, users may join the online social network via social-networking system 460 and then add connections (e.g., relationships) to a number of other users of social-networking system 460 to whom they want to be connected. Herein, the term “friend” may refer to any other user of social-networking system 460 with whom a user has formed a connection, association, or relationship via social-networking system 460.

In particular embodiments, social-networking system 460 may provide users with the ability to take actions on various types of items or objects, supported by social-networking system 460. As an example and not by way of limitation, the items and objects may include groups or social networks to which users of social-networking system 460 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 460 or by an external system of third-party system 470, which is separate from social-networking system 460 and coupled to social-networking system 460 via a network 410.

In particular embodiments, social-networking system 460 may be capable of linking a variety of entities. As an example and not by way of limitation, social-networking system 460 may enable users to interact with each other as well as receive content from third-party systems 470 or other entities, or to allow users to interact with these entities through an application programming interfaces (API) or other communication channels.

In particular embodiments, a third-party system 470 may include one or more types of servers, one or more data stores, one or more interfaces, including but not limited to APIs, one or more web services, one or more content sources, one or more networks, or any other suitable components, e.g., that servers may communicate with. A third-party system 470 may be operated by a different entity from an entity operating social-networking system 460. In particular embodiments, however, social-networking system 460 and third-party systems 470 may operate in conjunction with each other to provide social-networking services to users of social-networking system 460 or third-party systems 470. In this sense, social-networking system 460 may provide a platform, or backbone, which other systems, such as third-party systems 470, may use to provide social-networking services and functionality to users across the Internet.

In particular embodiments, a third-party system 470 may include a third-party content object provider. A third-party content object provider may include one or more sources of content objects, which may be communicated to a client system 430. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking system 460 also includes user-generated content objects, which may enhance a user's interactions with social-networking system 460. User-generated content may include anything a user can add, upload, send, or “post” to social-networking system 460. As an example and not by way of limitation, a user communicates posts to social-networking system 460 from a client system 430. Posts may include data such as status updates or other textual data, location information, photos, videos, links, music or other similar data or media. Content may also be added to social-networking system 460 by a third-party through a “communication channel,” such as a newsfeed or stream.

In particular embodiments, social-networking system 460 may include a variety of servers, sub-systems, programs, modules, logs, and data stores. In particular embodiments, social-networking system 460 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 460 may also include suitable components such as network interfaces, security mechanisms, load balancers, failover servers, management-and-network-operations consoles, other suitable components, or any suitable combination thereof. In particular embodiments, social-networking system 460 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 460 to one or more client systems 430 or one or more third-party system 470 via network 410. The web server may include a mail server or other messaging functionality for receiving and routing messages between social-networking system 460 and one or more client systems 430. An API-request server may allow a third-party system 470 to access information from social-networking system 460 by calling one or more APIs. An action logger may be used to receive communications from a web server about a user's actions on or off social-networking system 460. In conjunction with the action log, a third-party-content-object log may be maintained of user exposures to third-party-content objects. A notification controller may provide information regarding content objects to a client system 430. Information may be pushed to a client system 430 as notifications, or information may be pulled from client system 430 responsive to a request received from client system 430. Authorization servers may be used to enforce one or more privacy settings of the users of social-networking system 460. A privacy setting of a user determines how particular information associated with a user can be shared. The authorization server may allow users to opt in to or opt out of having their actions logged by social-networking system 460 or shared with other systems (e.g., third-party system 470), such as, for example, by setting appropriate privacy settings. Third-party-content-object stores may be used to store content objects received from third parties, such as a third-party system 470. Location stores may be used for storing location information received from client systems 430 associated with users. Advertisement-pricing modules may combine social information, the current time, location information, or other suitable information to provide relevant advertisements, in the form of notifications, to a user.

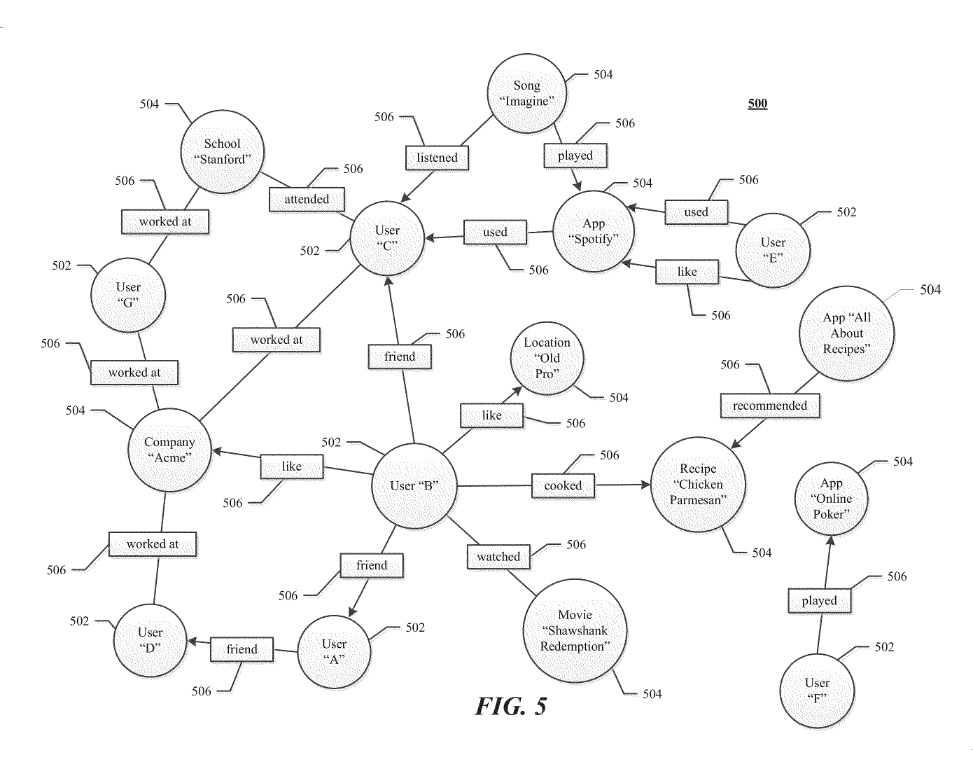

FIG. 5 illustrates example social graph 500. In particular embodiments, social-networking system 460 may store one or more social graphs 500 in one or more data stores. In particular embodiments, social graph 500 may include multiple nodes—which may include multiple user nodes 502 or multiple concept nodes 504—and multiple edges 506 connecting the nodes. Example social graph 500 illustrated in FIG. 5 is shown, for didactic purposes, in a two-dimensional visual map representation. In particular embodiments, a social-networking system 460, client system 430, or third-party system 470 may access social graph 500 and related social-graph information for suitable applications. The nodes and edges of social graph 500 may be stored as data objects, for example, in a data store (such as a social-graph database). Such a data store may include one or more searchable or queryable indexes of nodes or edges of social graph 500.

In particular embodiments, a user node 502 may correspond to a user of social-networking system 460. As an example and not by way of limitation, a user may be an individual (human user), an entity (e.g., an enterprise, business, or third-party application), or a group (e.g., of individuals or entities) that interacts or communicates with or over social-networking system 460. In particular embodiments, when a user registers for an account with social-networking system 460, social-networking system 460 may create a user node 502 corresponding to the user, and store the user node 502 in one or more data stores. Users and user nodes 502 described herein may, where appropriate, refer to registered users and user nodes 502 associated with registered users. In addition or as an alternative, users and user nodes 502 described herein may, where appropriate, refer to users that have not registered with social-networking system 460. In particular embodiments, a user node 502 may be associated with information provided by a user or information gathered by various systems, including social-networking system 460. As an example and not by way of limitation, a user may provide his or her name, profile picture, contact information, birth date, sex, marital status, family status, employment, education background, preferences, interests, or other demographic information. In particular embodiments, a user node 502 may be associated with one or more data objects corresponding to information associated with a user. In particular embodiments, a user node 502 may correspond to one or more webpages.

In particular embodiments, a concept node 504 may correspond to a concept. As an example and not by way of limitation, a concept may correspond to a place (such as, for example, a movie theater, restaurant, landmark, or city); a website (such as, for example, a website associated with social-network system 460 or a third-party website associated with a web-application server); an entity (such as, for example, a person, business, group, sports team, or celebrity); a resource (such as, for example, an audio file, video file, digital photo, text file, structured document, or application) which may be located within social-networking system 460 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 504 may be associated with information of a concept provided by a user or information gathered by various systems, including social-networking system 460. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 504 may be associated with one or more data objects corresponding to information associated with concept node 504. In particular embodiments, a concept node 504 may correspond to one or more webpages.

In particular embodiments, a node in social graph 500 may represent or be represented by a webpage (which may be referred to as a “profile page”). Profile pages may be hosted by or accessible to social-networking system 460. Profile pages may also be hosted on third-party websites associated with a third-party server 470. As an example and not by way of limitation, a profile page corresponding to a particular external webpage may be the particular external webpage and the profile page may correspond to a particular concept node 504. Profile pages may be viewable by all or a selected subset of other users. As an example and not by way of limitation, a user node 502 may have a corresponding user-profile page in which the corresponding user may add content, make declarations, or otherwise express himself or herself. As another example and not by way of limitation, a concept node 504 may have a corresponding concept-profile page in which one or more users may add content, make declarations, or express themselves, particularly in relation to the concept corresponding to concept node 504.

In particular embodiments, a concept node 504 may represent a third-party webpage or resource hosted by a third-party system 470. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check-in,” “eat,” “recommend,” or another suitable action or activity. A user viewing the third-party webpage may perform an action by selecting one of the icons (e.g., “check-in”), causing a client system 430 to send to social-networking system 460 a message indicating the user's action. In response to the message, social-networking system 460 may create an edge (e.g., a check-in-type edge) between a user node 502 corresponding to the user and a concept node 504 corresponding to the third-party webpage or resource and store edge 506 in one or more data stores.

In particular embodiments, a pair of nodes in social graph 500 may be connected to each other by one or more edges 506. An edge 506 connecting a pair of nodes may represent a relationship between the pair of nodes. In particular embodiments, an edge 506 may include or represent one or more data objects or attributes corresponding to the relationship between a pair of nodes. As an example and not by way of limitation, a first user may indicate that a second user is a “friend” of the first user. In response to this indication, social-networking system 460 may send a “friend request” to the second user. If the second user confirms the “friend request,” social-networking system 460 may create an edge 506 connecting the first user's user node 502 to the second user's user node 502 in social graph 500 and store edge 506 as social-graph information in one or more of data stores 464. In the example of FIG. 5, social graph 500 includes an edge 506 indicating a friend relation between user nodes 502 of user “A” and user “B” and an edge indicating a friend relation between user nodes 502 of user “C” and user “B.” Although this disclosure describes or illustrates particular edges 506 with particular attributes connecting particular user nodes 502, this disclosure contemplates any suitable edges 506 with any suitable attributes connecting user nodes 502. As an example and not by way of limitation, an edge 506 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 500 by one or more edges 506.

In particular embodiments, an edge 506 between a user node 502 and a concept node 504 may represent a particular action or activity performed by a user associated with user node 502 toward a concept associated with a concept node 504. As an example and not by way of limitation, as illustrated in FIG. 5, a user may “like,” “attended,” “played,” “listened,” “cooked,” “worked at,” or “watched” a concept, each of which may correspond to a edge type or subtype. A concept-profile page corresponding to a concept node 504 may include, for example, a selectable “check in” icon (such as, for example, a clickable “check in” icon) or a selectable “add to favorites” icon. Similarly, after a user clicks these icons, social-networking system 460 may create a “favorite” edge or a “check in” edge in response to a user's action corresponding to a respective action. As another example and not by way of limitation, a user (user “C”) may listen to a particular song (“Imagine”) using a particular application (SPOTIFY, which is an online music application). In this case, social-networking system 460 may create a “listened” edge 506 and a “used” edge (as illustrated in FIG. 5) between user nodes 502 corresponding to the user and concept nodes 504 corresponding to the song and application to indicate that the user listened to the song and used the application. Moreover, social-networking system 460 may create a “played” edge 506 (as illustrated in FIG. 5) between concept nodes 504 corresponding to the song and the application to indicate that the particular song was played by the particular application. In this case, “played” edge 506 corresponds to an action performed by an external application (SPOTIFY) on an external audio file (the song “Imagine”). Although this disclosure describes particular edges 506 with particular attributes connecting user nodes 502 and concept nodes 504, this disclosure contemplates any suitable edges 506 with any suitable attributes connecting user nodes 502 and concept nodes 504. Moreover, although this disclosure describes edges between a user node 502 and a concept node 504 representing a single relationship, this disclosure contemplates edges between a user node 502 and a concept node 504 representing one or more relationships. As an example and not by way of limitation, an edge 506 may represent both that a user likes and has used at a particular concept. Alternatively, another edge 506 may represent each type of relationship (or multiples of a single relationship) between a user node 502 and a concept node 504 (as illustrated in FIG. 5 between user node 502 for user “E” and concept node 504 for “SPOTIFY”).

In particular embodiments, social-networking system 460 may create an edge 506 between a user node 502 and a concept node 504 in social graph 500. As an example and not by way of limitation, a user viewing a concept-profile page (such as, for example, by using a web browser or a special-purpose application hosted by the user's client system 430) may indicate that he or she likes the concept represented by the concept node 504 by clicking or selecting a “Like” icon, which may cause the user's client system 430 to send to social-networking system 460 a message indicating the user's liking of the concept associated with the concept-profile page. In response to the message, social-networking system 460 may create an edge 506 between user node 502 associated with the user and concept node 504, as illustrated by “like” edge 506 between the user and concept node 504. In particular embodiments, social-networking system 460 may store an edge 506 in one or more data stores. In particular embodiments, an edge 506 may be automatically formed by social-networking system 460 in response to a particular user action. As an example and not by way of limitation, if a first user uploads a picture, watches a movie, or listens to a song, an edge 506 may be formed between user node 502 corresponding to the first user and concept nodes 504 corresponding to those concepts. Although this disclosure describes forming particular edges 506 in particular manners, this disclosure contemplates forming any suitable edges 506 in any suitable manner.

In particular embodiments, social-networking system 460 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 470 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, social-networking system 460 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part a the history of the user's actions. Coefficients may be used to predict any number of actions, which may be within or outside of the online social network. As an example and not by way of limitation, these actions may include various types of communications, such as sending messages, posting content, or commenting on content; various types of a observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, social-networking system 460 may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 400%). To calculate the coefficient of a user towards a particular object, the rating assigned to the user's actions may comprise, for example, 60% of the overall coefficient, while the relationship between the user and the object may comprise 40% of the overall coefficient. In particular embodiments, the social-networking system 460 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, social-networking system 460 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, social-networking system 460 may calculate a coefficient based on a user's actions. Social-networking system 460 may monitor such actions on the online social network, on a third-party system 470, on other suitable systems, or any combination thereof. Any suitable type of user actions may be tracked or monitored. Typical user actions include viewing profile pages, creating or posting content, interacting with content, tagging or being tagged in images, joining groups, listing and confirming attendance at events, checking-in at locations, liking particular pages, creating pages, and performing other tasks that facilitate social action. In particular embodiments, social-networking system 460 may calculate a coefficient based on the user's actions with particular types of content. The content may be associated with the online social network, a third-party system 470, or another suitable system. The content may include users, profile pages, posts, news stories, headlines, instant messages, chat room conversations, emails, advertisements, pictures, video, music, other suitable objects, or any combination thereof. Social-networking system 460 may analyze a user's actions to determine whether one or more of the actions indicate an affinity for subject matter, content, other users, and so forth. As an example and not by way of limitation, if a user may make frequently posts content related to “coffee” or variants thereof, social-networking system 460 may determine the user has a high coefficient with respect to the concept “coffee”. Particular actions or types of actions may be assigned a higher weight and/or rating than other actions, which may affect the overall calculated coefficient. As an example and not by way of limitation, if a first user emails a second user, the weight or the rating for the action may be higher than if the first user simply views the user-profile page for the second user.

In particular embodiments, social-networking system 460 may calculate a coefficient based on the type of relationship between particular objects. Referencing the social graph 500, social-networking system 460 may analyze the number and/or type of edges 506 connecting particular user nodes 502 and concept nodes 504 when calculating a coefficient. As an example and not by way of limitation, user nodes 502 that are connected by a spouse-type edge (representing that the two users are married) may be assigned a higher coefficient than a user nodes 502 that are connected by a friend-type edge. In other words, depending upon the weights assigned to the actions and relationships for the particular user, the overall affinity may be determined to be higher for content about the user's spouse than for content about the user's friend. In particular embodiments, the relationships a user has with another object may affect the weights and/or the ratings of the user's actions with respect to calculating the coefficient for that object. As an example and not by way of limitation, if a user is tagged in first photo, but merely likes a second photo, social-networking system 460 may determine that the user has a higher coefficient with respect to the first photo than the second photo because having a tagged-in-type relationship with content may be assigned a higher weight and/or rating than having a like-type relationship with content. In particular embodiments, social-networking system 460 may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, social-networking system 460 may determine that the first user should also have a relatively high coefficient for the particular object. In particular embodiments, the coefficient may be based on the degree of separation between particular objects. The lower coefficient may represent the decreasing likelihood that the first user will share an interest in content objects of the user that is indirectly connected to the first user in the social graph 500. As an example and not by way of limitation, social-graph entities that are closer in the social graph 500 (i.e., fewer degrees of separation) may have a higher coefficient than entities that are further apart in the social graph 500.

In particular embodiments, social-networking system 460 may calculate a coefficient based on location information. Objects that are geographically closer to each other may be considered to be more related or of more interest to each other than more distant objects. In particular embodiments, the coefficient of a user towards a particular object may be based on the proximity of the object's location to a current location associated with the user (or the location of a client system 430 of the user). A first user may be more interested in other users or concepts that are closer to the first user. As an example and not by way of limitation, if a user is one mile from an airport and two miles from a gas station, social-networking system 460 may determine that the user has a higher coefficient for the airport than the gas station based on the proximity of the airport to the user.

In particular embodiments, social-networking system 460 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, social-networking system 460 may provide information that is relevant to user's interests and current circumstances, increasing the likelihood that they will find such information of interest. In particular embodiments, social-networking system 460 may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular embodiments, social-networking system 460 may generate search results based on coefficient information. Search results for a particular user may be scored or ranked based on the coefficient associated with the search results with respect to the querying user. As an example and not by way of limitation, search results corresponding to objects with higher coefficients may be ranked higher on a search-results page than results corresponding to objects having lower coefficients.

In particular embodiments, social-networking system 460 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 470 (e.g., via an API or other communication channel), or from another suitable system. In response to the request, social-networking system 460 may calculate the coefficient (or access the coefficient information if it has previously been calculated and stored). In particular embodiments, social-networking system 460 may measure an affinity with respect to a particular process. Different processes (both internal and external to the online social network) may request a coefficient for a particular object or set of objects. Social-networking system 460 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular embodiments may utilize one or more systems, components, elements, functions, methods, operations, or steps disclosed in U.S. patent application Ser. No. 11/503093, filed 11 Aug. 2006, U.S. patent application Ser. No. 12/977027, filed 22 Dec. 2010, U.S. patent application Ser. No. 12/978265, filed 23 Dec. 2010, and U.S. patent application Ser. No. 13/632869, filed 1 Oct. 2012, each of which is incorporated by reference.

In particular embodiments, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. As an example and not by way of limitation, a user of the online social network may specify privacy settings for a user-profile page identify a set of users that may access the work experience information on the user-profile page, thus excluding other users from accessing the information. In particular embodiments, the privacy settings may specify a “blocked list” of users that should not be allowed to access certain information associated with the object. In other words, the blocked list may specify one or more users or entities for which an object is not visible. As an example and not by way of limitation, a user may specify a set of users that may not access photos albums associated with the user, thus excluding those users from accessing the photo albums (while also possibly allowing certain users not within the set of users to access the photo albums). In particular embodiments, privacy settings may be associated with particular social-graph elements. Privacy settings of a social-graph element, such as a node or an edge, may specify how the social-graph element, information associated with the social-graph element, or content objects associated with the social-graph element can be accessed using the online social network. As an example and not by way of limitation, a particular concept node 204 corresponding to a particular photo may have a privacy setting specifying that the photo may only be accessed by users tagged in the photo and their friends. In particular embodiments, privacy settings may allow users to opt in or opt out of having their actions logged by social-networking system 460 or shared with other systems (e.g., third-party system 470). In particular embodiments, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third-party systems 470, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In particular embodiments, one or more servers 462 may be authorization/privacy servers for enforcing privacy settings. In response to a request from a user (or other entity) for a particular object stored in a data store 464, social-networking system 460 may send a request to the data store 464 for the object. The request may identify the user associated with the request and may only be sent to the user (or a client system 430 of the user) if the authorization server determines that the user is authorized to access the object based on the privacy settings associated with the object. If the requesting user is not authorized to access the object, the authorization server may prevent the requested object from being retrieved from the data store 464, or may prevent the requested object from be sent to the user. In the search query context, an object may only be generated as a search result if the querying user is authorized to access the object. In other words, the object must have a visibility that is visible to the querying user. If the object has a visibility that is not visible to the user, the object may be excluded from the search results. Although this disclosure describes enforcing privacy settings in a particular manner, this disclosure contemplates enforcing privacy settings in any suitable manner.

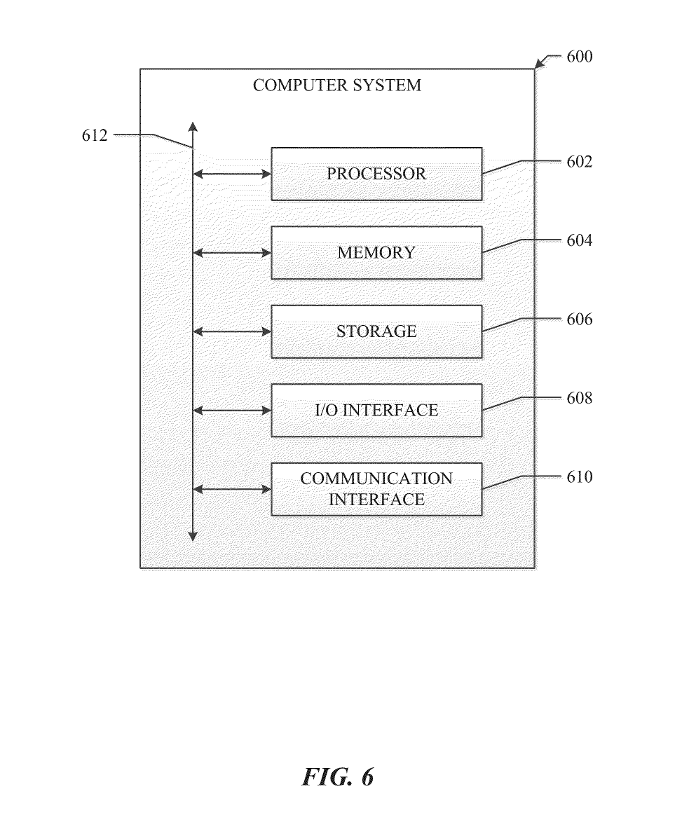

FIG. 6 illustrates an example computer system 600. In particular embodiments, one or more computer systems 600 perform one or more steps of one or more methods described or illustrated herein. In particular embodiments, one or more computer systems 600 provide functionality described or illustrated herein. In particular embodiments, software running on one or more computer systems 600 performs one or more steps of one or more methods described or illustrated herein or provides functionality described or illustrated herein. Particular embodiments include one or more portions of one or more computer systems 600. Herein, reference to a computer system may encompass a computing device, and vice versa, where appropriate. Moreover, reference to a computer system may encompass one or more computer systems, where appropriate.

This disclosure contemplates any suitable number of computer systems 600. This disclosure contemplates computer system 600 taking any suitable physical form. As example and not by way of limitation, computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 600 may include one or more computer systems 600; be unitary or distributed; span multiple locations; span multiple machines; span multiple data centers; or reside in a cloud, which may include one or more cloud components in one or more networks. Where appropriate, one or more computer systems 600 may perform without substantial spatial or temporal limitation one or more steps of one or more methods described or illustrated herein. As an example and not by way of limitation, one or more computer systems 600 may perform in real time or in batch mode one or more steps of one or more methods described or illustrated herein. One or more computer systems 600 may perform at different times or at different locations one or more steps of one or more methods described or illustrated herein, where appropriate.

In particular embodiments, computer system 600 includes a processor 602, memory 604, storage 606, an input/output (I/O) interface 608, a communication interface 610, and a bus 612. Although this disclosure describes and illustrates a particular computer system having a particular number of particular components in a particular arrangement, this disclosure contemplates any suitable computer system having any suitable number of any suitable components in any suitable arrangement.

In particular embodiments, processor 602 includes hardware for executing instructions, such as those making up a computer program. As an example and not by way of limitation, to execute instructions, processor 602 may retrieve (or fetch) the instructions from an internal register, an internal cache, memory 604, or storage 606; decode and execute them; and then write one or more results to an internal register, an internal cache, memory 604, or storage 606. In particular embodiments, processor 602 may include one or more internal caches for data, instructions, or addresses. This disclosure contemplates processor 602 including any suitable number of any suitable internal caches, where appropriate. As an example and not by way of limitation, processor 602 may include one or more instruction caches, one or more data caches, and one or more translation lookaside buffers (TLBs). Instructions in the instruction caches may be copies of instructions in memory 604 or storage 606, and the instruction caches may speed up retrieval of those instructions by processor 602. Data in the data caches may be copies of data in memory 604 or storage 606 for instructions executing at processor 602 to operate on; the results of previous instructions executed at processor 602 for access by subsequent instructions executing at processor 602 or for writing to memory 604 or storage 606; or other suitable data. The data caches may speed up read or write operations by processor 602. The TLBs may speed up virtual-address translation for processor 602. In particular embodiments, processor 602 may include one or more internal registers for data, instructions, or addresses. This disclosure contemplates processor 602 including any suitable number of any suitable internal registers, where appropriate. Where appropriate, processor 602 may include one or more arithmetic logic units (ALUs); be a multi-core processor; or include one or more processors 602. Although this disclosure describes and illustrates a particular processor, this disclosure contemplates any suitable processor.

In particular embodiments, memory 604 includes main memory for storing instructions for processor 602 to execute or data for processor 602 to operate on. As an example and not by way of limitation, computer system 600 may load instructions from storage 606 or another source (such as, for example, another computer system 600) to memory 604. Processor 602 may then load the instructions from memory 604 to an internal register or internal cache. To execute the instructions, processor 602 may retrieve the instructions from the internal register or internal cache and decode them. During or after execution of the instructions, processor 602 may write one or more results (which may be intermediate or final results) to the internal register or internal cache. Processor 602 may then write one or more of those results to memory 604. In particular embodiments, processor 602 executes only instructions in one or more internal registers or internal caches or in memory 604 (as opposed to storage 606 or elsewhere) and operates only on data in one or more internal registers or internal caches or in memory 604 (as opposed to storage 606 or elsewhere). One or more memory buses (which may each include an address bus and a data bus) may couple processor 602 to memory 604. Bus 612 may include one or more memory buses, as described below. In particular embodiments, one or more memory management units (MMUs) reside between processor 602 and memory 604 and facilitate accesses to memory 604 requested by processor 602. In particular embodiments, memory 604 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 604 may include one or more memories 604, where appropriate. Although this disclosure describes and illustrates particular memory, this disclosure contemplates any suitable memory.

In particular embodiments, storage 606 includes mass storage for data or instructions. As an example and not by way of limitation, storage 606 may include a hard disk drive (HDD), a floppy disk drive, flash memory, an optical disc, a magneto-optical disc, magnetic tape, or a Universal Serial Bus (USB) drive or a combination of two or more of these. Storage 606 may include removable or non-removable (or fixed) media, where appropriate. Storage 606 may be internal or external to computer system 600, where appropriate. In particular embodiments, storage 606 is non-volatile, solid-state memory. In particular embodiments, storage 606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 606 taking any suitable physical form. Storage 606 may include one or more storage control units facilitating communication between processor 602 and storage 606, where appropriate. Where appropriate, storage 606 may include one or more storages 606. Although this disclosure describes and illustrates particular storage, this disclosure contemplates any suitable storage.

In particular embodiments, I/O interface 608 includes hardware, software, or both, providing one or more interfaces for communication between computer system 600 and one or more I/O devices. Computer system 600 may include one or more of these I/O devices, where appropriate. One or more of these I/O devices may enable communication between a person and computer system 600. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 608 for them. Where appropriate, I/O interface 608 may include one or more device or software drivers enabling processor 602 to drive one or more of these I/O devices. I/O interface 608 may include one or more I/O interfaces 608, where appropriate. Although this disclosure describes and illustrates a particular I/O interface, this disclosure contemplates any suitable I/O interface.

In particular embodiments, communication interface 610 includes hardware, software, or both providing one or more interfaces for communication (such as, for example, packet-based communication) between computer system 600 and one or more other computer systems 600 or one or more networks. As an example and not by way of limitation, communication interface 610 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 610 for it. As an example and not by way of limitation, computer system 600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 600 may include any suitable communication interface 610 for any of these networks, where appropriate. Communication interface 610 may include one or more communication interfaces 610, where appropriate. Although this disclosure describes and illustrates a particular communication interface, this disclosure contemplates any suitable communication interface.

In particular embodiments, bus 612 includes hardware, software, or both coupling components of computer system 600 to each other. As an example and not by way of limitation, bus 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 612 may include one or more buses 612, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method comprising:
receiving a request to display a first portion of a list comprising one or more content items;
for each section of each of the content items in the first portion:
identifying a binder object corresponding to the section, wherein the binder object comprises data or content to be displayed within the context of the section;
binding, using the binder object, the data or content to a display object corresponding to the section; and
providing for display, for each of the content items in the first portion of the list, the display objects corresponding to the sections of the content items in the first portion.

2. The method of claim 1, further comprising:
receiving a request to display the list of content items;
generating, for each of the content items, a content item adapter object corresponding to the content item, wherein the generating is performed using a list adapter object corresponding to a list object representing the list of content items;
initializing each of the content item adapter objects with an index of sections required to display the content item corresponding to the content item adapter object;
generating, for each of the content item adapter objects, the binder objects corresponding to the sections required to display the content item; and
for each section of each of the content items, using the binder object corresponding to the section, preparing the data or content for the section.

3. The method of claim 2, wherein the preparing the data or content for the section comprises executing application logic to retrieve the data or content.

4. The method of claim 1, further comprising:
receiving updates adding new content items to the list of content items;
generating, for each of the new content items, a new content item adapter object corresponding to the new content item;
initializing each of the new content item adapter objects with an index of sections required to display the new content item corresponding to the new content item adapter object;
generating, for each of the new content item adapter objects, the binder objects corresponding to the sections required to display the new content item; and
for each section of each of the new content items, using the binder object corresponding to the section, preparing the data or content for the section.

5. The method of claim 1, further comprising:
receiving input comprising a request to display a second portion of the list comprising one or more specified content items; and
in response to receiving the input, for each of the sections of the content items in the first portion that do not appear in the second portion, unbinding the prepared data or content from the display object corresponding to the section.

6. The method of claim 1, further comprising:
receiving input comprising a request to send an application displaying the list of content items to the background; and
in response to receiving the input, for each of the sections of the content items in the first portion, unbinding the retrieved data or content from the display object corresponding to the section.

7. The method of claim 1, further comprising:
receiving a notification of an event;
in response to receiving the notification, using the binder object corresponding to at least one section of at least one of the content items in the first portion, updating the prepared data or content for the at least one section;
binding, using the binder object corresponding to the at least one section, the updated data or content to the display object corresponding to the at least one section; and
providing for display the display object corresponding to the at least one section.

8. The method of claim 7, wherein the binder corresponding to the at least one section is listening for particular types of events, and wherein the event is one of the particular types of events.

9. One or more computer-readable non-transitory storage media embodying software that is operable when executed to:
receive a request to display a first portion of a list comprising one or more content items;
for each section of each of the content items in the first portion:
identify a binder object corresponding to the section, wherein the binder object comprises data or content to be displayed within the context of the section;
bind, using the binder object, the data or content to a display object corresponding to the section; and
provide for display, for each of the content items in the first portion of the list, the display objects corresponding to the sections of the content items in the first portion.

10. The media of claim 9, further embodying software operable when executed to:
receive a request to display the list of content items;
generate, for each of the content items, a content item adapter object corresponding to the content item, wherein the generating is performed using a list adapter object corresponding to a list object representing the list of content items;
initialize each of the content item adapter objects with an index of sections required to display the content item corresponding to the content item adapter object;
generate, for each of the content item adapter objects, the binder objects corresponding to the sections required to display the content item; and
for each section of each of the content items, using the binder object corresponding to the section, prepare the data or content for the section.

11. The media of claim 10, wherein the software operable when executed to prepare the data or content for the section comprises the software operable when executed to execute application logic to retrieve the data or content.

12. The media of claim 9, further embodying software operable when executed to:
receive updates adding new content items to the list of content items;
generate, for each of the new content items, a new content item adapter object corresponding to the new content item;
initialize each of the new content item adapter objects with an index of sections required to display the new content item corresponding to the new content item adapter object;
generate, for each of the new content item adapter objects, the binder objects corresponding to the sections required to display the new content item; and
for each section of each of the new content items, using the binder object corresponding to the section, prepare the data or content for the section.

13. The media of claim 9, further embodying software operable when executed to:
receive input comprising a request to display a second portion of the list comprising one or more specified content items; and
in response to receiving the input, for each of the sections of the content items in the first portion that do not appear in the second portion, unbind the prepared data or content from the display object corresponding to the section.

14. The media of claim 9, further embodying software operable when executed to:
receive input comprising a request to send an application displaying the list of content items to the background; and
in response to receiving the input, for each of the sections of the content items in the first portion, unbind the retrieved data or content from the display object corresponding to the section.

15. The media of claim 9, further embodying software operable when executed to:
receive a notification of an event;
in response to receiving the notification, using the binder object corresponding to at least one section of at least one of the content items in the first portion, update the prepared data or content for the at least one section;
bind, using the binder object corresponding to the at least one section, the updated data or content to the display object corresponding to the at least one section; and
provide for display the display object corresponding to the at least one section.

16. The media of claim 15, wherein the binder corresponding to the at least one section is listening for particular types of events, and wherein the event is one of the particular types of events.

17. A system comprising: one or more processors; and a memory coupled to the processors comprising instructions executable by the processors, the processors being operable when executing the instructions to:
receive a request to display a first portion of a list comprising one or more content items;
for each section of each of the content items in the first portion:
identify a binder object corresponding to the section, wherein the binder object comprises data or content to be displayed within the context of the section;
bind, using the binder object, the data or content to a display object corresponding to the section; and
provide for display, for each of the content items in the first portion of the list, the display objects corresponding to the sections of the content items in the first portion.

18. The system of claim 17, wherein the processors are further operable when executing the instructions to:
receive a request to display the list of content items;
generate, for each of the content items, a content item adapter object corresponding to the content item, wherein the generating is performed using a list adapter object corresponding to a list object representing the list of content items;
initialize each of the content item adapter objects with an index of sections required to display the content item corresponding to the content item adapter object;
generate, for each of the content item adapter objects, the binder objects corresponding to the sections required to display the content item; and
for each section of each of the content items, using the binder object corresponding to the section, prepare the data or content for the section.

19. The system of claim 18, wherein the processors being operable when executing the instructions to prepare the data or content for the section comprises the processors being operable when executing the instructions to execute application logic to retrieve the data or content.

20. The system of claim 17, wherein the processors are further operable when executing the instructions to:
receive input comprising a request to display a second portion of the list comprising one or more specified content items; and
in response to receiving the input, for each of the sections of the content items in the first portion that do not appear in the second portion, unbind the prepared data or content from the display object corresponding to the section.
